(19) United States
(12) Patent Application Publication
(10) Pub. No.: US 2017/0223921 A1
(43) Pub. Date: Aug. 10, 2017

(54) ON-SITE CHEMICAL BLENDING AND DISPENSING SYSTEM

(71) Applicant: Delaware Capital Formation, Inc., Wilmington, DE (US)

(72) Inventors: Terry Tincher, Lebanon, OH (US); Philip M. McDermott, Cincinnati, OH (US)

(21) Appl. No.: 15/425,469

(22) Filed: Feb. 6, 2017

Related U.S. Application Data
(60) Provisional application No. 62/292,487, filed on Feb. 8, 2016.

(51) Int. Cl. A01J 7/04; G05D 11/13; G05D 7/06

(52) U.S. Cl. CPC A01J 7/04; G05D 7/0641; G05D 11/13

(57) ABSTRACT

Systems, methods, and computer program products for providing teat dip mixtures. A dispensing system mixes chemical components with a diluent such as water at a variety of concentrations on demand, and is configured to provide multiple teat dip mixtures each having a different composition to different holding tanks. A batch of a respective mixture may be dispensed in response to detecting a low level of the mixture in a respective holding tank. Users may also select a mixture having a particular concentration of one or more components to be dispensed into a particular holding tank by selecting the mixture from a list of pre-determined mixtures.

### CROSS-REFERENCE TO RELATED APPLICATION

This application claims the benefit of Provisional Application Ser. No. 62/292,487, filed Feb. 8, 2016 (pending), the disclosure of which is incorporated by reference herein.

### TECHNICAL FIELD

This invention generally relates to the application of chemical treatments to cattle teats for milking operations and, more particularly, to systems, methods, and computer program products that provide chemical solutions for both pre-teat dip and post-teat dip applications.

### BACKGROUND

Modern milking operations typically require users to apply a pre-teat dip and a post-teat dip to dairy cattle for disinfectant and teat-treatment purposes. A pre-teat dip refers to a solution applied to the cattle's teats prior to milking and a post-teat dip refers to a solution applied to the cattle's teats after milking. Pre- and post-teat dips are typically comprised of the same two chemical components, namely an iodine solution and an emollient solution, that are mixed together with water. However, the concentrations of the chemical components are normally different in pre- and post-teat dips. For example, a pre-teat dip may have a higher iodine concentration to prevent bacteria from entering the milk supply, while a post-teat dip may have a higher emollient concentration to prevent the cattle's teats from becoming chaffed.

Because each dip contains different concentrations of chemicals, a separate dedicated dispensing system is normally required for each type of teat dip. Typically, a large supply of pre-made pre-teat dip with fixed concentrations of iodine and emollient is stored in a large vessel such as, for example, a 250-gallon tote, and is pumped directly to the milking parlor. Likewise, a large supply of pre-made post-teat dip with fixed concentrations of iodine and emollient is stored in a separate large vessel for pumping to the milking parlor. However, the use of two separate dispensing systems is expensive, consumes a large amount of space, and has significant maintenance requirements.

Conventional teat dip dispensing systems are also inflexible with respect to the concentrations of the chemical components available for treating cattle because they use pre-made teat dips with fixed concentrations of iodine and emollient. However, there are circumstances in which users would desire to use teat dip solutions containing more or less of one or both components. For example, conditions such as weather, humidity, or other local issues may change, resulting in a need for more or less iodine or emollient in the pre- and/or post-teat dips. In excessively cold weather, users may desire a higher concentration of emollient in both the pre- and post-teat dips to prevent the cattle's teats from becoming dry. A higher concentration of emollient may also be desired in cases where the dairy cattle are milked at a high frequency. In cases where there is a concern that the cattle's teats have been exposed to a high level of bacteria, a user may desire a higher concentration of iodine.

With known dedicated dispensing systems, a user would need to hire a person with technical skills to manually adjust the mixture ratio in order to achieve the desired concentration, e.g. by adding an amount of one or more components to the reservoir of remaining pre- or post-teat dip. This requires additional labor and expense, achieves the desired concentration only after a significant delay, and may result in wasting some of the pre-made teat dip solutions.

Thus, improved systems, methods, and computer program products for dispensing teat dip on site are needed to improve the flexibility for providing different chemical concentrations for both pre-teat dip and post-teat dip at lower cost and with reduced space requirements.

### SUMMARY

In an embodiment of the invention, a system for dispensing teat dip mixtures is provided. The system includes a first flow control device configured to selectively provide a first component, a second flow control device configured to selectively provide a second component, a mixing chamber that is fluidically coupled to the first flow control device and the second flow control device, a third flow control device configured to selectively fluidically couple the mixing chamber to one of a first holding tank and a second holding tank, and a controller. The controller is in communication with each of the flow control devices, and is configured to execute a first dispense cycle in response to receiving a first signal indicative of a low level of a first mixture in the first holding tank, and a second dispense cycle in response to receiving a second signal indicative of a low level of a second mixture in the second holding tank. The controller executes the respective dispense cycle by causing the third flow control device to fluidically couple the mixing chamber to the respective holding tank, causing the first flow control device to provide a respective amount of the first component to the mixing chamber, and causing the second flow control device to provide a respective amount of the second component to the mixing chamber. The controller thereby causes the system to produce a batch of the respective mixture that flows from the mixing chamber into the respective holding tank to which the mixing chamber is fluidically coupled by the third flow control device.

In another embodiment of the invention, a method of dispensing teat dip mixtures is provided. The method includes receiving the one of the first signal indicative of the low level of the first mixture in the first holding tank and the second signal indicative of the low level of the second mixture in the second holding tank. The method further includes executing the first dispense cycle in response to receiving the first signal that produces the batch of the first mixture, and the second dispense cycle in response to receiving the second signal that produces the batch of the second mixture. The controller executes the respective dispense cycle by causing the first flow control device to provide the respective amount of the first component to the mixing chamber, causing the second flow control device to provide the respective amount of the second component to the mixing chamber, and causing the third flow control device to fluidically couple the mixing chamber to the respective holding tank so that the batch of the respective mixture flows from the mixing chamber into the respective holding tank.

In another embodiment of the invention, a computer program product for dispensing teat dip mixtures is provided. The computer program product includes a non-transitory computer-readable storage medium, and program code stored on the non-transitory computer-readable storage medium. The program code, when executed by one or more processors, causes the processors to receive the one of the first signal indicative of the low level of the first mixture in the first holding tank and the second signal indicative of the low level of the second mixture in the second holding tank. The program code further causes the processor to execute the first dispense cycle in response to receiving the first signal that produces the batch of the first mixture, and a second dispense cycle in response to receiving the second signal that produces the batch of the second mixture. The one or more processors execute the respective dispense cycle by causing the first flow control device to provide the respective amount of the first component to the mixing chamber, causing the second flow control device to provide the respective amount of the second component to the mixing chamber, and causing the third flow control device to fluidically couple the mixing chamber to the respective holding tank so that the batch of the respective mixture flows from the mixing chamber into the respective holding tank.

The above summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a diagrammatic view of an exemplary operating environment including a plurality of component sources, a dispensing system, and a plurality of holding tanks.

FIG. 2 is a front view of an embodiment of the dispensing system of FIG. 1.

FIG. 3 is a schematic diagram of another embodiment of the dispensing system of FIG. 1 illustrating additional details of the system.

### DETAILED DESCRIPTION

Embodiments of the invention are directed to systems, methods, and computer program products that provide teat dip mixtures. These mixtures may be solutions, emulsions, colloidal suspensions, liquid dispersions, or other mixtures of two or more components. A dispensing system may be configured to mix chemical components with water at a variety of concentrations to produce batches of teat dip mixtures. Rather than using multiple dedicated dispensing systems, e.g., to provide pre-teat dip and post-teat dip mixtures, the dispensing system may provide multiple teat dip mixtures having different compositions on-demand. This may enable a user to react immediately to a need for a mixture having a particular concentration of one or more components by simply selecting the mixture from a list of pre-determined mixtures. Advantageously, the dispensing system may allow users to save significant amounts of time, money, space, and mixture components as compared to systems that can only dispense one type of pre-mixed teat dip.

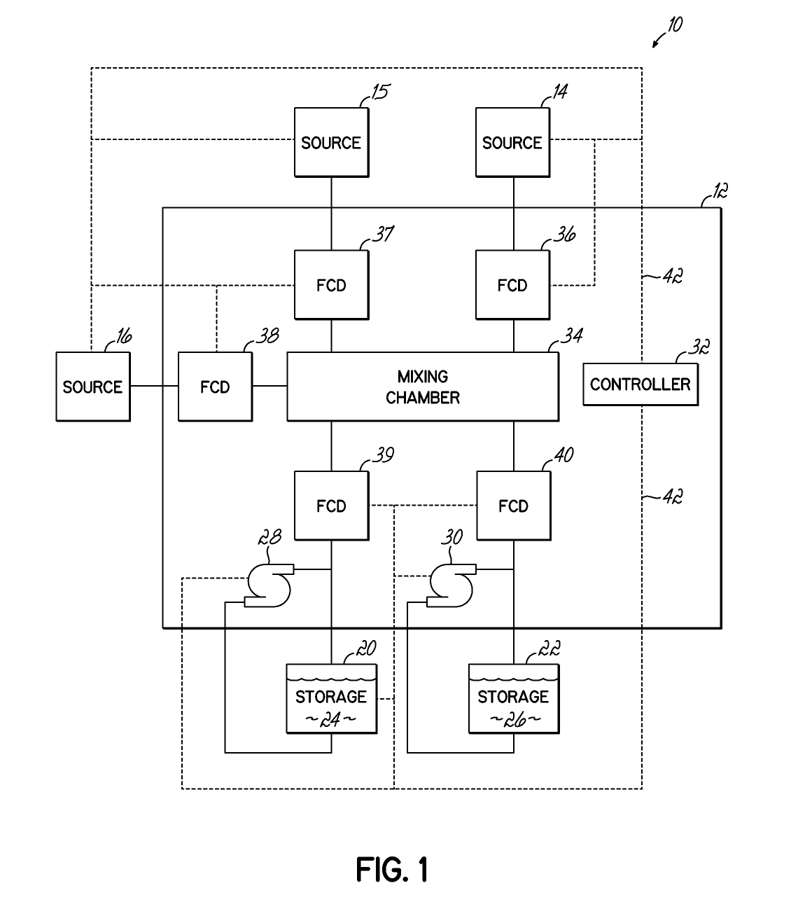

Referring now to FIG. 1, an operating environment 10 in accordance with an embodiment of the invention may include a dispensing system 12, one or more (e.g., three) sources 14-16 of components, and one or more (e.g., two) holding tanks 20, 22 for storing mixtures 24, 26 of the components. Each source 14-16 may include a reservoir or external supply of the component being sourced. For example, reservoir may comprise a container of a chemical solution, while an external supply may comprise a connection to a water main or other supply system.

The dispensing system 12 may include recirculating pumps 28, 30, a controller 32, a mixing chamber 34, and flow control devices 36-40. Each of the holding tanks 20, 22 may be fluidically coupled to one of the recirculating pumps 28, 30 so that the pump can draw the mixture 24, 26 from and circulate the mixture back into the respective holding tank. The mixture 24, 26 may be circulated, for example, to maintain the mixture 24, 26 in a homogenous state and/or to prevent settling.

Each of the flow control devices 36-40 may be in communication with the controller 32, and may include one or more pumps, valves, flow meters, pressure regulators, and/or any other device suitable for controlling or measuring flow through the flow control device. A valve may have an inlet and an outlet that are fluidically coupled when the valve is in an open state, and that are fluidically isolated when the valve is in a closed state. The controller 32 may be configured to selectively couple one or more of the sources 14-16 and holding tanks 20, 22 to the mixing chamber 34 by transmitting signals to the flow control devices 36-40. The controller 32 may selectively couple the sources 14-16 and/or holding tanks 20, 22 in one or more predefined sequences depending on the type of mixture being dispensed to the holding tanks 20, 22. To this end, the controller 32 may be configured to selectively activate the flow control devices 36-40 to provide predetermined amounts of components from one or more sources 14-16 into the mixing chamber 34, and provide the resulting mixture to the appropriate holding tank 20, 22. The controller 32 may also be in communication with the recirculating pumps 28, 30 to control activation thereof.

To monitor operation of the dispensing system 12, the controller 32 may communicate with one or more level sensors, flow sensors, overflow sensors, and/or flow switches. The level sensors may provide signals to the controller 32 indicative of an amount of the mixture 24, 26 in one or more of the holding tanks 20, 22 and/or an amount of component available in one or more reservoirs. The flow sensors may provide signals to the controller 32 indicative of a flow rate of a component or mixture through one or more of the flow control devices 36-40. The overflow sensors may provide signals to the controller 32 indicative of an overflow condition at one or more of the holding tanks 20, 22. The flow switches may provide signals to the controller 32 indicative of the presence or absence of a flow through the flow switch. The flow control devices 36-40, sensors, and other components of the dispensing system 12 may receive signals from, and transmit signals to the controller 32 over a suitable communication channel 42, e.g. a serial data channel.

The type of flow control device used to fluidically couple the sources 14-16 and/or holding tanks 20, 22 to the mixing chamber 34 may depend on the characteristics of the source/storage vessel. For sources that are not under pressure (e.g., a vessel containing a liquid chemical solution), the flow control device may include a pump (e.g., a peristaltic pump) that pumps a predetermined amount of the component into the mixing chamber 34 in response to receiving an activation signal from the controller 32. For a source that is under pressure (e.g. water from a city water main or well pump), the corresponding flow control device may include a valve, a pressure regulator, and/or a flow meter. For this type of flow control device, the valve may open in response to activation by the controller 32, thereby allowing the component to flow into the mixing chamber 34 under its own pressure. The flow meter may in turn provide a signal indicative of an amount of the component flowing through the flow control device.

Although each of the sources 14-16 and holding tanks 20, 22 is depicted as being fluidically coupled to the mixing chamber by a separate flow control device, embodiments of the invention are not so limited. For example, flow control devices may also be configured to selectively couple a single pump and/or flow meter to different sources sequentially so that a single flow control device can be used to provide different components to the mixing chamber 34. By way of another example, the mixing chamber 34 may be coupled to the holding tanks 20, 22 by a single flow control device comprising multiple valves or a single rotary valve.

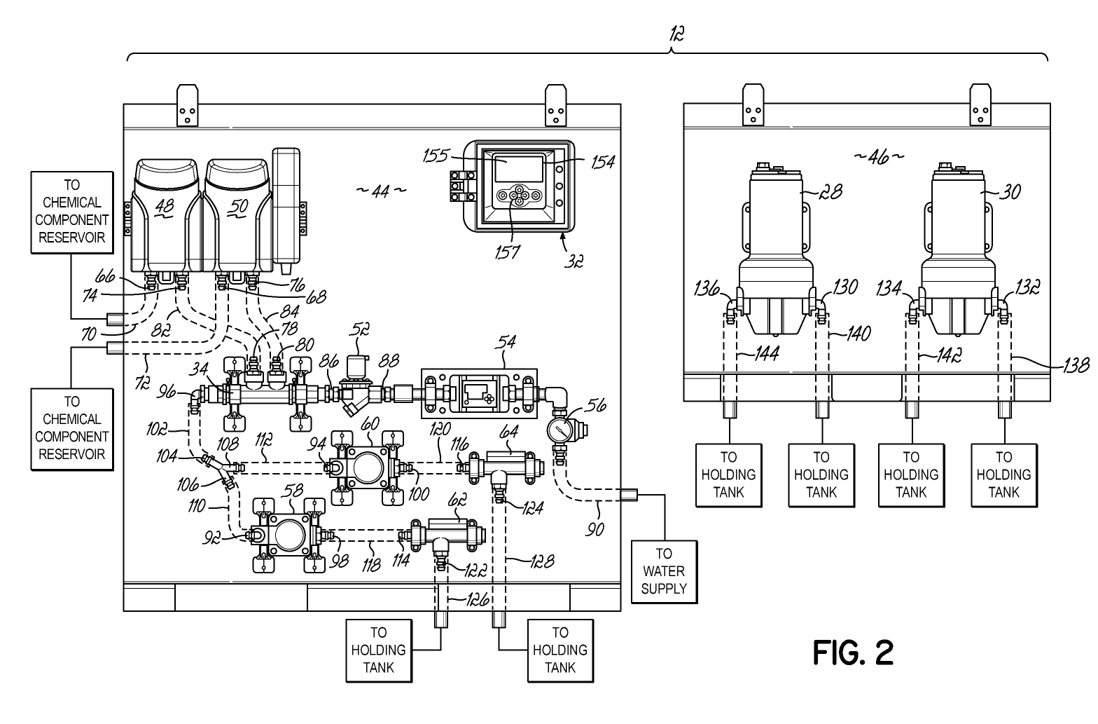

FIG. 2 depicts an embodiment of the dispensing system 12 having components mounted to one or more panels 44, 46. Each panel 44, 46 may be constructed of polyvinyl chloride (PVC) or another suitable material for mounting the components of dispensing system 12. The controller 32, mixing chamber 34, flow control devices comprising peristaltic pumps 48, 50, a flow control device comprising a valve 52, a flow meter 54, and a pressure regulator 56, and two flow control devices comprising valves 58, 60 and flow coupling devices 62, 64 are mounted on panel 44. By way of example, the peristaltic pumps may be INFINITY® peristaltic pumps, which are available from the Hydro Systems Co. of Cincinnati, Ohio, and the valves 52, 58, 60 may be solenoid valves. The recirculating pumps 28, 30 may be mounted to a separate panel 46, for example, to facilitate locating the recirculating pumps 28, 30 proximate to the holding tanks 20, 22.

Each of the peristaltic pumps 48, 50 may include an input port 66, 68 fluidically coupled to a source by a respective hose or tube 70, 72, and an output port 74, 76 fluidically coupled to an inlet port 78, 80 of mixing chamber 34 by a respective tube 82, 84. The sources may include reservoirs of chemical components, such as an iodine solution or an emollient solution. In response to being activated by the controller 32, the peristaltic pumps 48, 50 may pump a respective amount of the component from the source to which the pump is fluidically coupled into the mixing chamber 34. The controller 32 may control the amount of component pumped into the mixing chamber 34 based on an amount of time the respective pump is activated and/or data received from or transmitted to the respective pump indicating the amount of the component.

The valve 52 coupling diluent to the mixing chamber 34 may have an outlet port 86 fluidically coupled to the mixing chamber 34, and an inlet port 88 fluidically coupled to a source (e.g., a water supply) through the flow meter 54, pressure regulator 56, and a tube 90. The valve 52 may be activated (e.g., opened) by signals from the controller 32 to control the flow of the diluent used to dilute the components provided by peristaltic pumps 48, 50. The flow meter 54 and pressure regulator 56 may be provided upstream (as shown) or downstream of the valve 52, and may be in communication with the controller 32. The controller 32 may receive signals from the flow meter 54 and use these signals to monitor and control the flow of diluent through the valve 52.

Each valve 58, 60 may have an inlet port 92, 94 that is fluidically coupled to the mixing chamber 34, e.g., through an outlet port 96 of mixing chamber 34. Each valve 58, 60 may also have an outlet port 98, 100 that is fluidically coupled to one of the respective holding tanks 20, 22 by a respective flow coupling device 62, 64. The inlet ports 92, 94 of valves 58, 60 may be fluidly coupled to the outlet port 96 of mixing chamber 34 by a tube 102, a Y-branch 104 having outlet ports 106, 108, and tubes 110, 112. By opening valve 58 and closing valve 60, the controller 32 may direct the flow of a mixture exiting the mixing chamber 34 into the storage vessel that is fluidically coupled to valve 58. In contrast, by opening valve 60 and closing valve 58, the controller 32 may direct the flow of a mixture exiting the mixing chamber 34 into the storage vessel that is fluidically coupled to valve 60. An additional valve (not shown) may be configured to selectively couple the mixing chamber 34 to a waste solution line so that the controller 32 can flush the mixing chamber 34 without affecting the contents of the holding tanks 20, 22.

The flow coupling devices 62, 64 may include a check valve and/or flow switch that couples the outlet ports 98, 100 of valves 58, 60 to the holding tanks 20, 22. The flow coupling devices 62, 64 may monitor the flow of mixture (e.g., for flow coupling devices including a flow switch), and/or prevent mixture from back-flowing from the holding tanks 20, 22 into the mixing chamber 34 (e.g., for flow coupling devices including a check valve). Each of the flow coupling devices 62, 64 may include an inlet port 114, 116 that is fluidically coupled to the outlet port 98, 100 of the respective valve 58, 60 by a tube 118, 120, and an outlet port 122, 124 that is fluidically coupled to the respective holding tank 20, 22 by a tube 126, 128. The holding tanks 20, 22 may receive and store dispensed mixtures, e.g., a pre-teat dip mixture and a post-teat dip mixture. For example, the holding tank 20 may receive and contain a pre-teat dip mixture, and holding tank 22 may receive and contain a post-teat dip mixture.

Valve 58, flow coupling device 62, outlet port 106 of Y-branch 104, tube 110, tube 118, and tube 126 may collectively define a dispensing line for dispensing mixture into one of the storage vessels. Valve 60, flow coupling device 64, outlet port 108 of Y-branch 104, tube 112, tube 120, and tube 128 may collectively define a dispensing line for dispensing mixture into another of the storage vessels.

The recirculating pumps 28, 30 may be electrically powered, pneumatically powered, or powered by any other suitable source of power for circulating the stored mixtures 24, 26. The recirculating pumps 28, 30 may include respective inlet ports 130, 132 and outlet ports 134, 136. Each inlet port 130, 132 may be fluidically coupled to a respective one of the holding tanks 20, 22 by a respective tube 138, 140, and each outlet port 134, 136 may be fluidically coupled to the respective holding tanks 20, 22 by a respective tube 142, 144. The recirculating pumps 28, 30 may recirculate the contents of the holding tanks 20, 22 by drawing the respective mixture from one part of the tank (e.g., the bottom) and returning the mixture to another part of the tank (e.g., the top). While the recirculating pumps 28, 30 are shown as being mounted on panel 46, it should be understood that the recirculating pumps 28, 30 could be mounted in another location, such as on panel 44, in which case panel 46 could be omitted.

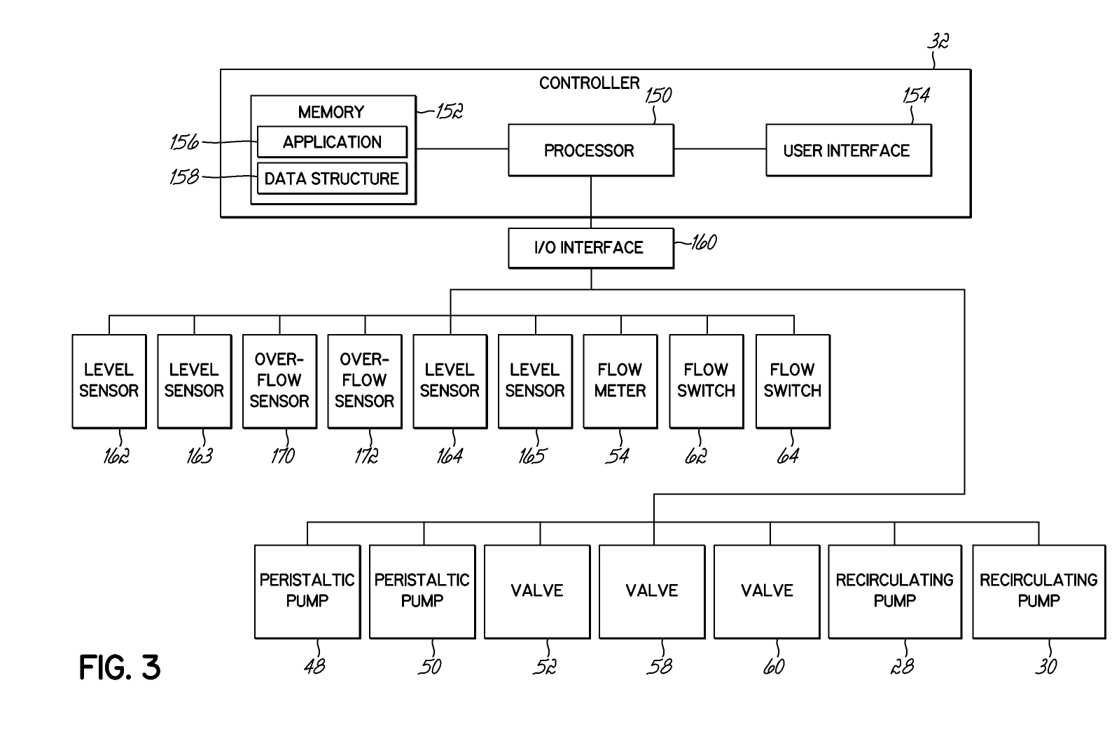

Referring now to FIG. 3, and with continued reference to FIG. 2, the controller 32 may include a processor 150, a memory 152, and user interface 154. The processor 150 may include one or more devices configured to manipulate signals and/or data based on operational instructions that are stored in memory 152. Memory 152 may include a single memory device or a plurality of memory devices configured to store information in the form of data. The memory 152 may store computer program code embodied as one or more computer software applications comprising instructions executed by the processor 150, such as a controller application 156. One or more data structures 158 may also reside in memory 152, and may be used by the processor 150 and/or controller application 156 to store and process data.

A sensor module interface or “I/O interface” 160 may operatively couple the processor 150 to other components of dispensing system 12, such as the recirculating pumps 28, 30, peristaltic pumps 48, 50, valves 52, 58, 60, flow meter 54, and flow coupling devices 62, 64. The I/O interface 160 may also operatively couple the processor 150 to one or more level sensors 162-165 and one or more overflow sensors 170, 172. The I/O interface 160 may include signal processing circuits that condition incoming and outgoing signals so that the signals are compatible with both the processor 150 and the components to which the processor 150 is coupled. To this end, the I/O interface 160 may include analog-to-digital (ND) and/or digital-to-analog (D/A) converters, voltage level and/or frequency shifting circuits, optical isolation and/or driver circuits, data busses, and/or any other analog or digital circuitry suitable for coupling the processor 150 to the other components of the cooking apparatus.

The user interface 154 may be operatively coupled to the processor 150 of controller 32 in a known manner to provide a human-machine interface that allows a user to interact with the controller 32. The user interface 154 may include a display 155 (e.g., a Liquid Cristal Display (LCD)) having suitable audio and visual indicators capable of providing information to the user. The user interface 154 may also include input devices and/or controls, such as a keypad 157 capable of accepting commands or input from the user and transmitting the entered input to the processor 150. In this way, the user interface 154 may enable manual initiation or selection of system functions, for example, during set-up and operation of the dispensing system 12.

The controller 32 may be configured to cause the dispensing system 12 to execute dispense cycles. For example, the controller 32 may be preprogrammed with a number of mixing formulas having various concentrations of chemical components and water, e.g., 20 different mixing formulas. The display 155 may present the various preprogrammed mixing formulas (e.g., by displaying menu with a number of user selectable options), and the user may use the keypad 157 to select one of the formulas depending on the user's needs.

In response to the user selecting a formula, the controller 32 may communicate with components of the dispensing system 12 to mix and dispense a mixture having concentrations based on the selected formula. Advantageously, this feature may enable users to adjust the iodine and/or emollient concentrations of the dispensed mixture without manual intervention or programming of the controller 32. Rather, the controller 32 may transmits signals (e.g., data signals defining an amount of a component) to the peristaltic pumps 48, 50 to pump the appropriate amounts of the first and second chemical components into the mixing chamber 34. In the mixing chamber 34, the chemical components may be mixed together with water. As discussed in further detail below, the dispensing system 12 may mix and dispense batches of mixtures in a cyclical manner. For example, the dispensing system 12 may generate a one-gallon batch of pre- or post-teat dip at a time, thus defining a one-gallon dispense cycle.

The I/O interface 160 may be part of the controller 32, or may be a separate module that provides a single interface to the controller 32. The use of a separate module may facilitate operation of the dispensing system 12 with different end use configurations (e.g. different sensors and/or flow control devices) without customizing the controller 32 for each end use configuration. In any case, the controller 32 may transmit and/or receive data packets and/or signals, or otherwise communicate with the other components of dispensing system 12, via the I/O interface 160.

The level sensors 162-165 may be used to establish threshold levels of the dispensed mixtures in holding tanks 20, 22. To this end, the level sensors 162-165 may be positioned within each holding tank 20, 22 at a depth corresponding to a minimum level of the mixture. Because the volumes of the holding tanks 20, 22 may vary depending on the application (e.g. some may hold up to 100 gallons), the user may adjust the depths of the level sensors 162-165 relative to the top of the respective holding tank to locate the level sensors 162-165 at the appropriate depth for that tank. For example, the user may set the level sensors 162-165 such that the minimum level corresponds to a fluid volume of 20 gallons, 30 gallons, 50 gallons, or any other desired amount. If the level of the mixture in the holding tank drops below the minimum level, the corresponding level sensor may transmit a signal to the controller 32 indicative of a low level of the mixture in the holding tank.

One or more of the level sensors 162-165 may be provided by the Low Level Alarm probe assembly described above, or any other suitable probe able to withstand harsh chemicals such as iodine. In any event, the level sensors 162-165, when wetted, may transmit a signal to the controller 32 indicating that the level of mixture in the respective holding tank is above the minimum level. In response to receiving this signal, the controller 32 may inhibit dispensing operations to the holding tank 20, 22 in question, and/or display a status of the tank as being full via the user interface 154.

An overflow sensor 170, 172 may be positioned at or near the top of each holding tank 20, 22 to enable the controller 32 to detect an overflow condition. This may enable the controller 32 to prevent the dispensing system 12 from filling the holding tanks 20, 22 beyond a maximum level. The overflow sensors 170, 172 may be substantially similar to level sensors 162-165, and may include, for example, the Low Level Alarm probe assembly sold by Hydro Systems Co.

In response to the level of mixture in a holding tank rising high enough to wet the respective overflow sensor 170, 172, the overflow sensor 170, 172 may transmit a signal to the controller 32 indicating that further dispensing could result in overfilling of the holding tank. In response to receiving this signal, the controller 32 may terminate the dispense cycle and alert the user of the overflow condition via an error message. Once the controller 32 has detected an overflow condition, the dispensing system 12 may require a manual restart to clear the error message and resume dispensing operations.

One or more of the level sensors 162-165 may also be provided in one or more of the sources 14-16. For example, for a source including a container of the component, a level sensor may be placed in the container. These level sensors may be positioned at depths corresponding to a minimum operational level of the component in question. In response to the level of a component dropping below its respective minimum operational level, the level sensor 162-165 may transmit a signal to the controller 32 indicating that the level of the component is below the minimum operational level, and therefore needs replenishing.

In response to receiving this signal, the controller 32 may inhibit dispensing operations that require the component in question until the source has been replenished to a point at or above the minimum operational level of the component. This replenishment may cause the respective level sensor 162-165 to be wetted, which in turn may cause the sensor to stop transmitting the signal indicating the level of the component is below the minimum operational level. In response to receiving this signal, the controller 32 may cancel any alarms that were triggered and/or remove any inhibit flags set due to the component in question being below the minimum operational level.

In operation, the user may select a formula via the controller 32. The selected formula may have, for example, specific concentrations of iodine and emollient corresponding to a desired pre- or post-teat dip mixture. In response to the selected formula corresponding to a pre-teat dip mixture, the controller 32 may communicate with the level sensor 162-164 used to detect a minimum level condition of this mixture 24, 26 in the holding tank 20, 22 for the pre-teat dip mixture. In response to the signal received from this level sensor 162-164 indicating the sensor is not wetted, the controller 32 may determine the level of pre-teat dip mixture in the holding tank is below the minimum level, and initiate a dispense cycle for that mixture.

In response to the selected formula corresponding to a post-teat dip mixture, the controller 32 may communicate with the level sensor 162-164 used to detect a minimum level condition of that mixture 24, 26 in the holding tank 20, 22 for the post-dip mixture. In response to the signal received from this level sensor 162-164 indicating the sensor is not wetted, the controller 32 may determine the level of post-teat dip mixture in the holding tank is below the minimum level, and initiate a dispense cycle for that mixture.

Contemporaneously with determining the levels of mixture 24, 26 in the holding tanks 20, 22, the controller 32 may further take readings from one or more level sensors 162-164 associated with the levels of the components needed to produce the selected mixture. If any of the levels are below the minimum operational level for that component, the controller 32 may inhibit the dispense cycle for the mixture and trigger an alarm notifying the user of the low component condition.

To initiate a dispense cycle, the controller 32 may transmit a signal to the valve 52 for the source of diluent (e.g., water) that causes the valve 52 to open. The controller 32 may then communicate with the flow meter 54 to verify that sufficient water is flowing into the mixing chamber 34 from the supply to execute the dispense cycle.

If the controller 32 determines sufficient water is flowing into the mixing chamber 34, the controller 32 may transmit signals to one or more of the peristaltic pumps 48, 50 and valves 58, 60. These signals may cause the respective pumps to pump a desired amount of the respective component from the source into the mixing chamber 34, and may open/close the valves 58, 60 so that the mixture is directed into the appropriate holding tank 20, 22. The components pumped into the mixing chamber 34 may mix with the water flowing through the mixing chamber 34, and be flushed into the respective holding tank 20, 22 to generate a batch of the selected mixture.

In an embodiment of the invention, the peristaltic pumps 48, 50 may base the amount of component pumped into the mixing chamber 34 at least in part on calibration data stored in a local memory of the peristaltic pump 48, 50. This calibration data may be generated, for example, during a calibration operation performed during installation of the dispensing system 12. To facilitate calibration, a three way valve (not shown) may be coupled to the discharge side of each of the peristaltic pumps 48, 50. Advantageously, performing a calibration operation at setup and storing individual pump calibration data in each pump may increase the accuracy of the dispensing system as compared to dispensing systems lacking this feature. For example, embodiments of the dispensing system 12 having the calibration feature may provide accuracy equal to or greater than 1% of the components to diluent ratio.

An exemplary calibration procedure may begin with the user selecting a Setup Menu using the user interface 154, and entering a correct setup password. The user may then proceed to a Pump Calibration Menu and select a method of calibration. Two exemplary methods for pump calibration include time based and volume based calibration. Time based calibration may involve dispensing a component into a graduated measuring container for a predetermine amount of time (e.g., 20 seconds), determining the amount dispensed, and inputting that amount into the user interface 154. The volume based method may involve dispensing a set amount of component (e.g., 8 oz.) into the graduated container by starting the pump and stopping the pump when the set amount has been dispensed. The controller 32 may then determine the amount of time required to dispense that set volume, and use this time as a calibration factor.

As the chemical components enter the mixing chamber 34, they may be mixed together with water from the source to form the selected mixture. The amount of water present in the mixture may be determined by setting the water flow rate to maintain the concentrations of the components in the resulting mixture in accordance with the selected formula. To that end, the pressure regulator 56 may be adjusted to achieve a desired flow rate for the water, e.g., during calibration of the system. The controller 32 may verify the flow rate is within an allowed range by monitoring the digital readout of the flow meter 54 during dispensing and/or flushing operations. In addition to functioning as a diluent in the mixture, the water may also serve to transport the mixed chemicals from the mixing chamber 34 through the appropriate dispensing line to the appropriate holding tank, and to flush the mixing chamber 34 between dispense cycles.

The mixture may exit the mixing chamber 34 via the outlet port 96 of mixing chamber 34, and travel through the tube 102 toward the Y-branch 104. The mixture is then directed into the appropriate dispensing line based on the state of the valves 58, 60. If the selected formula corresponds to a pre-dip mixture, then the controller 32 transmits a signal that opens the valve 58, 60 coupling the mixing chamber 34 to the holding tank that is to receive the pre-dip mixture, and verifies that the valve 58, 60 coupling the mixing chamber 34 to the post-dip mixture holding tank is closed. Likewise, if the selected formula corresponds to a post-dip mixture, then the controller 32 transmits a signal that opens the valve 58, 60 coupling the mixing chamber 34 to the holding tank that is to receive the post-dip mixture, and verifies that the valve 58, 60 coupling the mixing chamber 34 to the pre-dip mixture holding tank is closed.

Thus, the mixture flows from the outlet port 96 of mixing chamber 34 through the outlet 106, 108 of the Y-branch 104 and into the open valve 58, 60 via tube 110. From the open valve 58, 60, the mixture flows into the respective flow coupling devices 62, 64 via the corresponding connecting tube 118, 120, and is dispensed into the respective holding tank 20, 22 via the respective tube 126, 128.

During the dispense cycle, the controller 32 may communicate with one or more of the flow coupling devices 62, 64 to verify that the entire mixture is flowing through the appropriate dispensing line, and not the dispensing line coupling the mixing chamber to the wrong holding tank. The controller 32 may also communicate with one or more of the flow coupling devices 62, 64 to determine the flow rate of the mixture. The controller 32 may compare this flow rate to a predetermined value to verify that a minimum expected flow rate of the mixture has been achieved. The controller 32 may thereby monitor the integrity of the dispensing line in question.

Once the dispensing system 12 has begun dispensing the mixture into the holding tank, it may be desirable to recirculate the dispensed mixture in order to maintain a homogeneous mixture and/or to prevent the mixture from stratifying. To this end, portions of the mixture may be extracted from, and subsequently returned to the holding tank by a respective recirculating pump 28, 30 via the corresponding recirculating tubes 136, 138, 140, 142. The recirculating pumps 28, 30 may only be active during a dispensing operation (e.g., to extend the lives of the recirculating pumps 28, 30, conserve power, or reduce noise), may be activated periodically, or may be continuously active (e.g., to prevent settling or stratification of the mixture in the holding tanks).

After the dispensing system 12 has completed an initial dispense cycle, e.g., dispensed a batch of the desired mixture into the appropriate holding tank, the controller 32 may automatically initiate subsequent dispense cycles to produce additional batches. In particular, the dispensing system 12 may enter a replenishing mode in order to achieve and/or maintain the desired level of mixtures as set by the level sensors 162-165. To this end, if one or more of the level sensors 162-165 corresponding to a holding tank 20, 22 has not been wetted by the dispensed mixture, the level sensor 162-165 may transmit a signal to the controller 32 indicating that the respective desired level of mixture has not been achieved. The controller 32 may respond by initiating an additional dispense cycle, as previously described, to generate additional batches until the desired level of mixture has been reached.

The amounts of pre- and post-dip mixture used during a milking operation may be different. Based on this variance in usage, the dispensing system 12 may have a priority replenishing mode to determine which of the holding tanks 20, 22 should be serviced first in the event the mixture in both tanks is below the minimum level. For embodiments of the dispensing system 12 having this feature, the user may select which holding tank 20, 22 has priority. In the event that the level sensors 162-165 indicate shortages of both the pre- and post-dip mixtures at the same time (e.g., the signals are overlapping signals), the controller 32 may initiate dispensing operations for the priority mixture before addressing the non-priority mixture.

At least because the dispensing system 12 is configured to dispense both pre- and post-teat dip mixtures, the dispensing system 12 may include unique features not provided by dedicated dispensing systems. These unique features may be configured to avoid issues such as cross-contamination between mixtures and inaccurate mixing. For example, the controller 32 may be configured to inhibit signals that would activate the peristaltic pumps 48, 50 until the controller 32 determines diluent is flowing through the mixing chamber 34 at or above a minimum flow rate. This determination may be made by receiving a signal from the flow meter 54 and/or a flow switch associated with the mixing chamber 34 indicating that a minimum flow rate of water is entering the mixing chamber 34.

The controller 32 may be further configured to monitor the flow rate of the diluent during the dispensing operation. If the minimum flow rate is not maintained during the dispensing operation, the flow meter 54 and/or flow switch may transmit a signal to the controller 32 indicating that insufficient water is flowing into the mixing chamber 34. In response to receiving this signal, the controller 32 may deactivate or close the valve 52. The controller 32 may then transmit a shut-off command to the peristaltic pumps 48, 50 to cease pumping the respective components into the mixing chamber 34. The dispensing system 12 may thereby avoid wasting chemical components and/or accidentally dispensing a mixture having too high of a concentration of the chemical components.

After the dispensing system 12 has completed sufficient dispensing operations to reach the desired level of mixture in one of the holding tanks 20, 22, water may continue to flow through the mixing chamber 34 from the water supply in a flushing operation. This flushing operation may remove chemical residue from the mixing chamber 34 and thereby reduce the potential for cross contamination between mixtures.

There may be a variety of circumstances in which the dispensing system 12 can experience some sort of error or failure mode. The controller 32 may be configured to address such situations by alerting the user and/or halting operation of the dispensing system 12. The dispensing system 12 may be halted, for example, upon detecting certain failure modes from which the dispensing system 12 may not be able to recover without manual intervention. In such cases, the dispensing system 12 may require a manual restart to resume dispensing operations.

In addition to providing numerous unique operational features, the dispensing system 12 may also provide a number of user-friendly benefits. In particular, the user interface 154 of controller 32 may be configured to facilitate operation of the dispensing system 12. In particular, the user interface 154 may facilitate selection of the desired mixture formulas.

By way of example, the controller 32 may be password protected in order to prevent unauthorized use of the dispensing system 12. The user interface 154 may also be configured to visually display all alerts and failure modes, thus bringing errors to the user's attention. Alerts may also be recorded and saved in data files stored in the memory 152 of controller 32.

The controller 32 may be configured to store data indicative of the productivity of the dispensing system 12 in memory 152. For example, the controller's memory 152 may log a daily history of the dispensing system 12. This history may include the formulas selected, the run times of each source (e.g., iodine, emollient, and water), the amounts of each source used, and the number of completed and stopped runs. This and/or other data stored in the memory 152 of controller 32 may be used to generate reports relating to the dispensing system 12. These reports may include productivity reports, formula reports, diagnostic reports, and activity log reports. Advantageously, this reporting feature may avoid the need for manual tabulations. The generation of data reports by the controller 32 may also enable more frequent reporting, such as at the end of each work shift or at the completion of each pre-teat dip/milking/post-teat dip cycle.

The controller 32 may further include a data port (not shown) for receiving a removable storage device. This data port may enable the user to automatically update programming information of the dispensing system 12 and/or download log files stored in the controller's memory 152 onto another device. For example, the controller 32 may include a USB port for receiving a removable flash drive or other memory device. The controller 32 may be further configured to, in response to detecting the presence of the removable memory device, upload updated program files and/or applications from the memory device, and/or download data to the memory device. The I/O interface 160 of controller 32 may also support communication using Ethernet, WiFi, Bluetooth, short range radio-frequency, and/or cellular connections point protocols in order to transmit alerts and data reports to remote devices.

The user interface 154 may be configured to display graphical menus that provide the user with selectable actions. These actions may cause the system to perform an operation (e.g., execute a dispense cycle), change a setting, or bring up another graphical menu. This menu-driven interface may facilitate operation of the dispensing system 12 by avoiding the need for the user to memorize commands. The use of graphical menus may reduce the amount of training users require to operate the dispensing system 12. Exemplary menus may include a main menu, an abort operation menu, a utilities menu, a Personal Id Number (PIN) entry menu, a prime pump menu, a select pump menu, a total run count menu, a password setup menu, a run report menu, an installer service menu, a calibration menu, or any other suitable menu.

By way of example, a calibration by time may be performed by selecting the pump to be calibrated from a set of menu options provided by the user interface 154. The user interface 154 may then display a time calibration screen for the selected pump. If a previous calibration has taken place, the input volume may be displayed. The pump may start in response to the user selecting a menu option (e.g., “Enter”) and run for a predetermined amount of time, e.g., 20 seconds. Once the pump stops, an input screen that allows the user to enter the volume pumped may be displayed. The amount dispensed may then be entered for that pump.

As another example, calibrating the pump by volume may include selecting the pump to be calibrated from the menu options. In response, the user interface 154 may display the volume calibration screen for the selected pump. The user may then start and stop the pump by selecting a corresponding menu option on the calibration screen.

As yet another example, the pressure regulator may be calibrated by activating a water flush option on a prime/flush menu to activate the valve 52. The user may then adjust the regulator so the flow meter reads within a desired range (e.g., between 0.38-0.41 gallons per minute).

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system for dispensing teat dip mixtures, the system comprising:
a first flow control device configured to selectively provide a first component;
a second flow control device configured to selectively provide a second component;
a mixing chamber that is fluidically coupled to the first flow control device and the second flow control device;
a third flow control device configured to selectively fluidically couple the mixing chamber to one of a first holding tank and a second holding tank; and
a controller in communication with each of the flow control devices and configured to execute a first dispense cycle in response to receiving a first signal indicative of a low level of a first mixture in the first holding tank, and a second dispense cycle in response to receiving a second signal indicative of a low level of a second mixture in the second holding tank,
the controller executing the respective dispense cycle by causing the third flow control device to fluidically couple the mixing chamber to the respective holding tank, causing the first flow control device to provide a respective amount of the first component to the mixing chamber, and causing the second flow control device to provide a respective amount of the second component to the mixing chamber to produce a first batch of the respective mixture that flows from the mixing chamber into the respective holding tank to which the mixing chamber is fluidically coupled by the third flow control device.

2. The system of claim 1 wherein the third flow control device comprises:
a first valve in communication with the controller that selectively fluidically couples the mixing chamber to the first holding tank; and
a second valve in communication with the controller that selectively fluidically couples the mixing chamber to the second holding tank,
wherein the controller causes the third flow control device to fluidically couple the mixing chamber to the respective holding tank by causing the one of the first and second valves coupled to the respective holding tank to be in an open state, and causing the other of the first and second valves to be in a closed state.

3. The system of claim 2 wherein the third flow control device includes a flow meter, and the controller is further configured to:
receive a third signal from the flow meter indicative of a flow rate through the third flow control device;
compare the flow rate to a minimum expected flow rate; and
in response to the flow rate being less than the minimum expected flow rate, terminate the dispense cycle.

4. The system of claim 1 further comprising:
a user interface in communication with the controller,
wherein the controller is further configured to:
cause the user interface to display a plurality of user selectable formulas;
receive a third signal from the user interface indicative of a user selecting a formula from the plurality of user selectable formulas; and
based on the selected formula, determine the respective amount of the first component and the respective amount of the second component for the respective dispense cycle.

5. The system of claim 1 wherein the first flow control device includes a pump having a memory that stores calibration data, and the pump provides the respective amount of the first component to the mixing chamber based at least in part on the calibration data.

6. The system of claim 1 wherein the controller is further configured to:
receive a third signal indicative of a level of the first component being below a minimum operational level in a reservoir;
in response to receiving the third signal, determine if the respective dispense cycle requires the controller to provide the first component; and
if the respective dispense cycle requires the controller to provide the first component, inhibit the respective dispense cycle.

7. The system of claim 1 further comprising:
a fourth flow control device for providing a diluent,
wherein the controller is further configured to cause the fourth flow control device to provide a third amount of the diluent to the mixing chamber, the diluent mixing with the respective amount of the first component and the respective amount of the second component, and flushing the respective mixture into the respective holding tank.

8. The system of claim 1 further comprising:
a recirculating pump fluidically coupled to the respective holding tank and in communication with the controller,
wherein the controller is further configured to activate the recirculating pump during the respective dispense cycle.

9. The system of claim 1 wherein the controller is further configured to:
in response to receiving a respective signal indicative of the low level of the respective mixture in the respective holding tank after completion of the respective dispense cycle, execute another dispense cycle to dispense a second batch of the first mixture into the respective holding tank.

10. The system of claim 1 wherein the controller is further configured to:
in response to reception of the first signal and the second signal overlapping, determine a priority of the first holding tank relative to the second holding tank;
execute the respective dispense cycle to the first holding tank if the first holding tank has a higher priority than the second holding tank; and
execute the respective dispense cycle to the second holding tank if the first holding tank has a lower priority than the second holding tank.

11. The system of claim 1 further comprising:
an overflow sensor in communication with the controller and configured to detect an overflow condition in the respective holding tank,
wherein the controller is further configured to terminate the respective dispense cycle in response to receiving a third signal from the overflow sensor indicative of the overflow condition.

12. The system of claim 1 wherein the first component is a chemical solution and the second component is a diluent.

13. A method of dispensing teat dip mixtures comprising:
receiving, at a controller, one of a first signal indicative of a low level of a first mixture in a first holding tank and a second signal indicative of a low level of a second mixture in a second holding tank; and
executing, by the controller, a first dispense cycle in response to receiving the first signal that produces a first batch of the first mixture, and a second dispense cycle in response to receiving the second signal that produces a first batch of the second mixture;
the controller executing the respective dispense cycle by causing a first flow control device to provide a respective amount of a first component to a mixing chamber, causing a second flow control device to provide a respective amount of a second component to the mixing chamber, and causing a third flow control device to fluidically couple the mixing chamber to the respective holding tank so that the first batch of the respective mixture flows from the mixing chamber into the respective holding tank.

14. The method of claim 13 wherein causing the third flow control device to fluidically couple the mixing chamber to the respective holding tank comprises:
causing one of a first valve that selectively fluidically couples the mixing chamber to the first holding tank and a second valve that selectively fluidically couples the mixing chamber to the second holding tank to be in an open state, and causing the other of the first and second valves to be in a closed state.

15. The method of claim 13 further comprising:
causing a user interface to display a plurality of user selectable formulas;
receiving a third signal indicative of a user selecting a formula from the plurality of user selectable formulas; and
based on the selected formula, determining the respective amount of the first component and the respective amount of the second component for the respective dispense cycle.

16. The method of claim 13 further comprising:
receiving a third signal indicative of a level of the first component being below a minimum operational level in a reservoir;
in response to receiving the third signal, determining if the respective dispense cycle requires the controller to provide the first component; and
if the respective dispense cycle requires the controller to provide the first component, inhibiting the respective dispense cycle.

17. The method of claim 13 further comprising:
in response to receiving a respective signal indicative of the low level of the respective mixture in the respective holding tank after completion of the respective dispense cycle, executing another dispense cycle to dispense a second batch of the respective mixture into the respective holding tank.

18. The method of claim 13 further comprising:
in response to reception of the first signal and the second signal overlapping, determining a priority of the first holding tank relative to the second holding tank;
executing the respective dispense cycle to the first holding tank if the first holding tank has a higher priority than the second holding tank; and
executing the respective dispense cycle to the second holding tank if the first holding tank has a lower priority than the second holding tank.

19. The method of claim 13 further comprising:
terminating the first dispense cycle in response to receiving a third signal indicative of an overflow condition.

20. A computer program product for dispensing teat dip mixtures, the computer program product comprising:
a non-transitory computer-readable storage medium; and
program code stored on the non-transitory computer-readable storage medium that, when executed by one or more processors, causes the one or more processors to:
receive one of a first signal indicative of a low level of a first mixture in a first holding tank and a second signal indicative of a low level of a second mixture in a second holding tank; and
execute a first dispense cycle in response to receiving the first signal that produces a first batch of the first mixture, and a second dispense cycle in response to receiving the second signal that produces a first batch of the second mixture;
the one or more processors executing the respective dispense cycle by causing a first flow control device to provide a respective amount of a first component to a mixing chamber, causing a second flow control device to provide a respective amount of a second component to the mixing chamber, and causing a third flow control device to fluidically couple the mixing chamber to the respective holding tank so that the first batch of the respective mixture flows from the mixing chamber into the respective holding tank.
